(19) United States
(12) Patent Application Publication
(10) Pub. No.: US 2005/0151853 A1
(43) Pub. Date: Jul. 14, 2005

(54) Digital camera capable of recording and reproducing video signal

(75) Inventor: Inh-seok Suh, Suwon-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/994,578

(22) Filed: Nov. 22, 2004

(30) Foreign Application Priority Data
Jan. 13, 2004 (KR) 2004-2250

(51) Int. Cl. H04N 5/225; H04N 7/04; H04N 7/00; H04N 11/00

(52) U.S. Cl. 348/220.1; 348/552; 348/231.3

(57) ABSTRACT

A digital camera that records and reproduces an external video signal is provided. The digital camera includes: a still image processing unit that generates a still image data by photographing a subject; a video processing unit that receives the external video signal, and generates moving picture data; a memory card on which the still image data and the moving picture data are recorded; a displaying unit that outputs the still image data and the moving picture data; and a controlling unit that compresses the generated moving picture data and records the moving picture data on the memory card, and outputs the moving picture data stored in the memory card to the displaying unit after restoring the moving picture data.

### BACKGROUND OF THE INVENTION

This application claims the priority of Korean Patent Application No. 2004-2250, filed on Jan. 13, 2004, in the Korean Intellectual Property Office, the disclosure of which is incorporated herein in its entirety by reference.

1. Field of the Invention

The present invention relates to a digital camera that can record and reproduce a video signal, and more particularly, to a digital camera that can store a video signal as compressed moving picture data in a memory after converting the video signal into a luminance signal and a color difference signal appropriate for compressing, and displaying the moving picture data by restoring the compressed and stored moving picture data.

2. Description of the Related Art

A digital camera performs an analog-to-digital conversion of a still image sensed by electric charges that are temporarily stored in a sensor via a charge coupled device (CCD). The CCD is a solid state pickup device that stores the image in a memory, and then displays the image stored in the memory on a display device. Recently, functionality such as a portable memory device, the ability to process a moving picture in a relatively short time by continuously storing and reproducing still images, and the ability to receive a television (TV) video or radio audio signal have been added to digital cameras.

Korean Patent Publication No. 1998-68477 discloses a digital camera that can process video signals. FIG. 1 is a block diagram of the digital camera disclosed in the cited reference. The digital camera includes a lens (not shown), a photoelectric converter, a video signal processing unit, and an external video signal input unit. The external video signal input unit is connected to an external video device via a cable, and transmits a video signal from the external video device to a switch. A TV receiving unit receives a signal from a public broadcasting station working on a specific channel and processes the received signal. Specifically, the tuner tunes to a specific channel based on a control signal T.C received from a controller, selects a video signal of a TV (which is a public broadcasting device), receives the video signal via the antenna, and then outputs the video signal as an IF signal. The IF processor outputs a composite baseband video signal to the switch. The switch selects and outputs the video signal input from the photoelectric converter, the external video signal inputting unit, and the IF processor. When using, for example, a slide switch, a user may directly select a video signal and output the selected video signal. When using a multiplexer that is switched according to a control signal, a video signal is selected and output when the multiplexer is switched by a control signal S.C of the controller that detected the pressing of a key by the user. A key operating unit provides key data that corresponds to a key operated by a user of the controller. An operating key that operates the switching of the switch by a direct manipulation of the user or an operating key that provides key data to the controller to perform the switching operation is included in the key operating unit. The controller controls the overall operation of the digital camera including the TV receiving unit according to the key data transmitted from the key operating unit by the user. Also, the controller outputs the control signal S.C to drive the switch according to an operation mode selected by the key data. When a TV receiving mode is selected, the controller outputs the control signal T.C to tune the tuner to a selected channel so that the selected channel may be viewed.

However, the digital camera capable of processing a video signal disclosed in the cited reference simply has the tuner in it and outputs a video signal to a liquid crystal display (LCD). It cannot record or reproduce the video signal or an external video signal. In addition, the ability to store a large amount of moving picture data in a limited memory capacity is not provided. If the moving picture data is recorded on and reproduced from a recording medium such as magnetic tape by installing the recording medium in the digital camera, then the digital camera is not different from a video camera recorder, and the volume and power requirements will increase.

### SUMMARY OF THE INVENTION

The present invention provides a digital camera that can record moving image data, which is generated after receiving a video signal, on a memory card and reproduce the moving image data.

The present invention also provides a digital camera that can convert and compress moving image data, which is generated after receiving a video signal, and record and reproduce the moving image data.

The present invention also provides a digital camera that can record and reproduce moving image data after converting the high-resolution moving image data of a public broadcasting device into a reduced resolution that corresponds to a low-resolution displaying device installed in the digital camera.

According to an aspect of the present invention, there is provided a digital camera that records and reproduces both still image data generated by photographing a subject and moving image data generated by receiving an external video signal. The digital camera includes: a still image processing unit that generates the still image data by photographing the subject; a video processing unit that receives the external video signal and generates moving picture data; a memory card on which the still image data and the moving picture data are recorded; a displaying unit that outputs the still image data and the moving picture data; and a controlling unit that compresses the generated moving picture data, records the moving picture data on the memory card, and outputs the moving picture data stored in the memory card to the displaying unit after restoring the moving picture data.

Particularly, the video processing unit includes: a receiving unit that receives the external video signal and a video signal converter that converts the received external video signal into a luminance signal and a color difference signal. The receiving unit comprises a tuner and an intermediate frequency processor. After receiving a tuning control signal from the controlling unit, the tuner selects a specific channel, receives a public broadcasting signal, and outputs the intermediate frequency video signal of the specific channel to the intermediate frequency processor. The intermediate frequency processor converts the video signal into a red, green and blue (RGB) composite baseband video signal. The video signal converter then converts the RGB composite video signal into a luminance signal and a color difference signal.

The controlling unit comprises a sub-sampling module, a compressing module and a restoring module. The sub-sampling module receives the luminance signal and the color difference signal and reduces the color difference information of the color difference signal. The compressing module compresses the luminance signal and the reduced color difference signal and generates moving picture data. The controlling unit records the compressed moving picture data on the memory card. The restoring module receives the compressed moving picture data from the memory card, restores the luminance and the reduced color difference signal from the compressed moving picture data and outputs the compressed moving picture data to the displaying unit.

According to another aspect of the present invention, there is provided a digital camera that can record and reproduce both still image data generated by photographing a subject and moving image data generated by receiving an external video signal. The digital camera includes: a still image processing unit that generates the still image data by photographing the subject; a video processing unit that receives an external video signal having a predetermined original resolution and generates moving picture data; a memory card on which the still image data and the moving picture data are recorded; a displaying unit that outputs the still image data and the moving picture data according to a predetermined displaying resolution; and a controlling unit that reduces the generated moving picture data to correspond to the displaying resolution of the displaying unit, records the moving picture data on the memory card, and outputs to the displaying unit the moving picture data that was stored in the memory card after being reduced.

The video processing unit includes: a receiving unit that receives the external video signal and a video signal converter that converts the received external video signal into a luminance signal and a color difference signal. The receiving unit comprises a tuner and an intermediate frequency processor. After receiving a tuning control signal from the controlling unit, the tuner selects a specific channel, receives a public broadcasting signal, and outputs the intermediate frequency video signal of the specific channel to the intermediate frequency processor. The intermediate frequency processor converts the video signal into a RGB composite baseband video signal. The video signal converter then converts the RGB composite video signal into a luminance signal and a color difference signal.

The controlling unit includes a resolution module that receives the luminance signal and the color difference signal and reduces n horizontal and vertical pixels of the original resolution of the luminance signal and the color difference signal in a predetermined ratio that corresponds to the horizontal and vertical pixels of the displaying resolution of the display unit. The controlling unit records the reduced resolution moving picture data on the memory card.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital camera having a conventional television (TV) receiving function;

FIG. 2 is a block diagram of a digital camera according to an embodiment of the present invention;

FIG. 3 is a block diagram of a video processing unit of the digital camera according to the present invention;

FIG. 4 is a view illustrating locations of 4:2:2 or 4:2:0 luminance and color difference signals in a moving picture experts group (MPEG) method;

FIG. 5 is a block diagram to explain a compression algorithm and a compressing module used in a video signal converter and a controller according to an embodiment of the present invention;

FIG. 6 is a block diagram of an entire digital camera according to an embodiment of the present invention;

FIG. 7A is a view illustrating a video signal having a horizontal and vertical pixel resolution that corresponds to public broadcasting;

FIG. 7B is a view illustrating the video signal of FIG. 7A reduced by a predetermined ratio along the horizontal and vertical pixels according to an embodiment of the present invention; and

FIG. 8 is a block diagram of an entire digital camera according to another embodiment of the present invention.

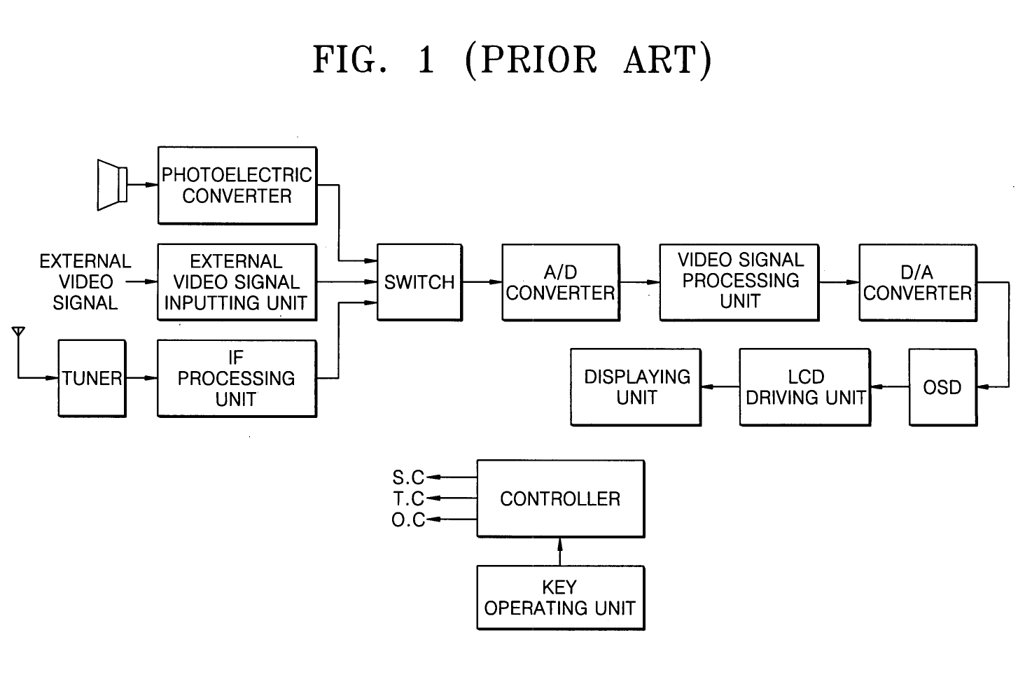

### DETAILED DESCRIPTION OF THE INVENTION

A digital camera according to the present invention will now be described more fully with reference to the accompanying drawings, in which exemplary embodiments of the invention are shown.

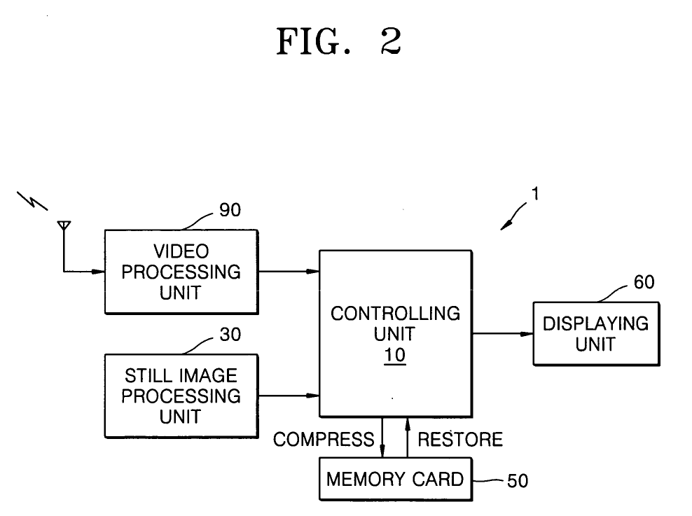

FIG. 2 is a block diagram of a digital camera 1 according to an embodiment of the present invention. Referring to FIG. 2, a video processing unit 90 is included in the digital camera 1 in addition to a still image processing unit 30, a controlling unit 10, a memory card 50, and a displaying unit 60, which are included in a conventional digital camera. The controlling unit 10 compresses moving picture data, and records and restores the moving picture data in and from the memory card 50. The still image processing unit 30 photographs a still image of a subject and generates still image data, and the video processing unit 90 receives an external video signal and generates moving picture data. The controlling unit 10 compresses the generated still image data and the moving picture data and records the data in the memory card 50. The controlling unit 10 restores the stored still image data and the moving picture data from the memory card and outputs it to the displaying unit 60.

When the digital camera 1 is in a television (TV) receiving mode, received external video data is directly output to the displaying unit 60 and displayed without having to undergo the compressing and restoring processes. When the digital camera 1 is in a recording mode, the received external video data is stored in the memory card 50 after going through the compressing process. When the digital camera 1 is in a reproducing mode, the compressed moving picture data recorded on the memory card 50 is restored and output via the displaying unit 60. Thus, a user may view the moving picture.

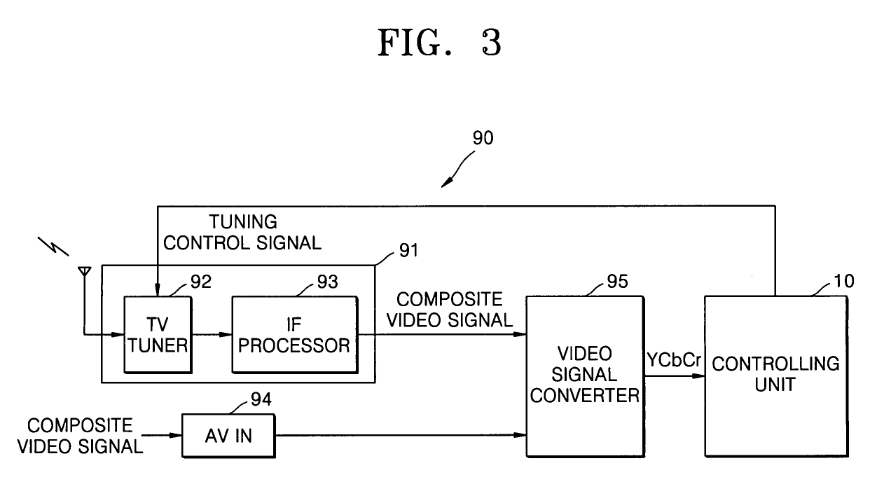

FIG. 3 is a block diagram of the video processing unit 90 of the digital camera 1 according to the present invention. Referring to FIG. 3, the video processing unit 90 includes a receiving unit 91 that receives an external video signal, and a video signal converter 95 that converts the received external video signal into a luminance signal Y and color difference signals Cb and Cr. The receiving unit 91 includes a TV tuner 92 and an IF processor 93. The TV tuner 92 selects a video signal of a TV, a public broadcasting device, by tuning into the specific channel designated by the tuning control signal T.C received from the controlling unit 10. The TV tuner 92 receives the video signal via an antenna. The TV tuner 92 outputs an intermediate frequency (IF) video signal of the specific channel to the IF processor 93. The IF processor 93 converts the signal into a red, green, and blue (RGB) composite baseband video signal in which all the red, green, and blue signal information is mixed together. The video signal converter 95 then converts the composite video signal into the luminance signal Y and the color difference signals Cb and Cr.

In addition, the video signal converter 95 may further include an audio-video (A/V) input terminal 94 that receives an external composite video signal. Thus, the digital camera 1 may also receive a composite video signal from a conventional video playing device (e.g., a video tape recorder (VTR), a digital versatile disc (DVD) player, an image out device, etc.) via the A/V input terminal 94, and output the composite video signal in real-time or record the composite video signal on the memory card 50.

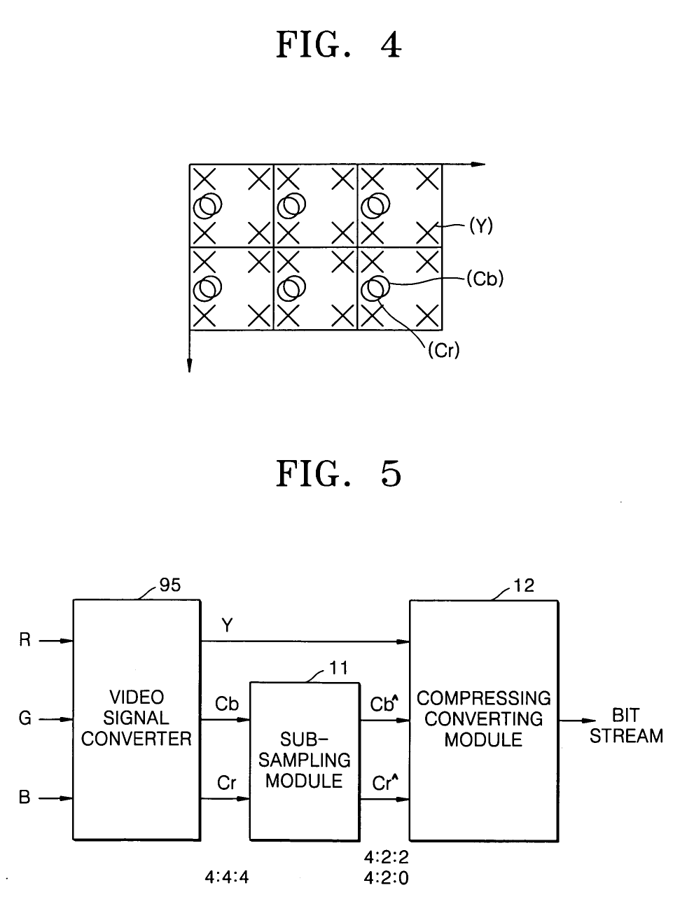

FIG. 4 is a view illustrating locations of 4:2:2 or 4:2:0 luminance and color difference signals in a moving picture experts group (MPEG) method. FIG. 5 is a block diagram to explain a compression algorithm and a compressing module used in the video signal converter 95 and a controlling unit according to an embodiment of the present invention. In the present invention, although the MPEG method is described, the scope of the present invention is not limited thereto.

Referring to FIG. 4, a digital color image may be expressed in 8 bits of red, green, and blue (RGB) values. However, an RGB domain is inefficient in color image compression due to correlation between the RGB data values. Therefore, a luminance-color difference domain, which has a signal energy compaction characteristic that has less correlation to signals, is used. In this case, the signals should be compressed in consideration of the fact that the human perception is dull to the color difference signals Cb and Cr and sensitive to the luminance signal Y.

The luminance signal Y denotes the degree of brightness of an image, and in the International Telecommunication Union-Radiocommunication (ITU-R) recommendation 601, a luminance of a pixel is denoted by 8 bits. The color difference signals Cb and Cr denote color information of an image, and show the color of a pixel using two 8 bit color difference signals in the ITY-R recommendation 601. A coordinate that shows colors is called “color space.” In a common representation of Y, Cb, and Cr used in the MPEG method, as illustrated in FIG. 4, a pixel is expressed using 8 bits of information for the luminance Y, 8 bits of information for the color difference Cb, and 8 bits information for the color difference Cr. In reality, first, a luminance signal Y and color difference signals (B-Y) and (R-Y) are calculated, and are converted into Y, (B-Y), and (R-Y) signals. Then, the color difference signals (B-Y) and (R-Y) undergo sampling to finally obtain Y, Cb, and Cr signals to reduce the amount of information when transmitting the signals. Thus, 24 bits of information is allocated to one pixel.

The process of reducing color difference information is based on the fact that the human eye is not sensitive to colors. If the color difference information is not reduced, the ratio of the luminance signal Y to the color difference signals Cb and Cr is expressed as 4:4:4, if the color difference information is reduced by half in the width direction, is expressed as 4:2:2, and if the color difference information is reduced by half in the width and length directions, is expressed as 4:2:0. Therefore, in case of the ratio 4:2:0, the color difference information is ¼ of the luminance information. In the MPEG method, after receiving signals of 4:2:2 or 4:2:0 ratios, video signals are composite compressed by composting compression algorithms such as a discrete cosine transform (DCT), quantization, and motion detection.

The compression module illustrated in FIG. 5 includes the video signal converter 95 that receives the RGB composite video signal and converts it into a luminance signal Y and color difference signals Cb and Cr, a sub-sampling module 11 that converts 4:4:4 color difference signals Cb and Cr into 4:2:2 or 4:2:0, and a compress-convert module 12 that compresses and converts the 4:2:2 or 4:2:0 color difference signals Cb\hat{ } and Cr\hat{ } by data conversion and quantization. In particular, the video signal converter 95 converts the RGB composite video signal into an 8 bit luminance signal Y and two 8 bit color difference signals Cb and Cr. Then, the sub-sampling module 11 filters the 4:4:4 color difference signals Cb and Cr via a prefilter (not shown) and sub-samples them into 4:2:2 or 4:2:0 color difference signals Cb\hat{ } and Cr\hat{ } to reduce the data amount. The compressing-converting module 12 lossy compresses the luminance signal Y and 4:2:2 or 4:2:0 color difference signals Cb\hat{ } and Cr\hat{ } using the DCT and quantization of a frequency substrate through conversion and quantization, and reduces the space repetitiveness of a video. Quantization is a method of encoding input video data using predetermined information called quantum. When input video data cannot be accurately encoded using quantization, quantization generates a code that can restore data most similar to the input video data. For example, if data before quantization are 120, 115, 55, 70, 81, 83, 88, and 75, data quantized with a multiple of 4 of 30, 29, 14, 17, 20, 21, 22, and 19 can be generated.

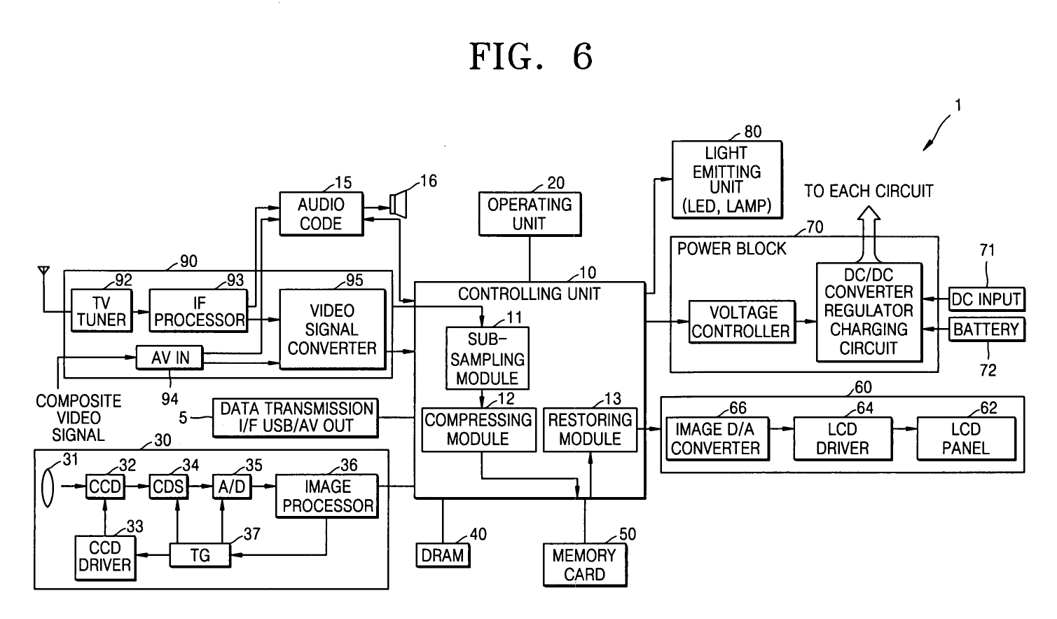

FIG. 6 is a block diagram of an entire digital camera 1 according to an embodiment of the present invention. A controlling unit 10 includes a microprocessor (not shown) and a system controller (not shown) that controls the digital camera 1 according to a predetermined program. The controlling unit 10 controls the operation of each circuit within the digital camera 1 based on a command signal from an operating unit 20. Also, the controlling unit 10 includes an internal memory (not shown) in which a control program or various data etc. are temporary stored, a sub-sampling module 11 that receives a luminance signal Y and the color difference signals Cb and Cr and reduces the color difference signals Cb and Cr to Cb\hat{ } and Cr\hat{ }, a compressing module 12 that compresses the luminance signal Y and the color difference signals Cb\hat{ } and Cr\hat{ }, and a restoring module 13 that restores the compressed moving image data.

The operating unit 20 is an element that allows a user to input various commands into the digital camera 1. The operating unit 20 includes a key switch (not shown), a power switch (not shown), a zoom switch (not shown), a release switch (not shown), etc. The key switch may include a mode selection switch to select an operating mode; a menu key to command displaying of a menu screen; an input key to select a category in the menu screen, move a cursor, or command transferring or restoring of a playing image; an execution key to command confirmation of a selected category or execution of an operation; and a cancel key to erase a desired selection category or cancel a command.

In a power block 70 of the digital camera 1, power is supplied from external power connected to a direct current (DC) input terminal 71 or a battery 72. A secondary battery may be used as the battery 72. The power supplied by the DC input terminal 71 or the battery 72 is converted into the needed voltage by a power circuit including, for example, a DC/DC converter and a regulator, and then is supplied to each circuit within the digital camera 1. Also, the power block 70 may include a voltage detecting circuit that acts as an element for detecting the remaining battery amount or a charging circuit to charge the battery 72. The controlling unit 10 transmits a command signal to the voltage controller to control the operation of the power block 70, such as controlling the charging operation, and simultaneously acquires various types of information needed for control, for example, the type of power or battery voltage used by the power block 70.

The controlling unit 10 determines the state of the digital camera 1 based on a signal received from the power block 70, the internal circuits, and the input signal from the operating unit 20. The controlling unit 10 controls the luminescence of the light emitting unit 80 based on the state of the digital camera.

Also, the digital camera 1 includes a data communication interface 5 to transmit and receive data between a personal computer and other external devices. The data communication interface 5 may include an audio-video (A/V) out terminal that outputs moving picture data restored by a restoring module 13, besides, for example, a universal serial bus (USB), IEEE 1394, and a Bluetooth.

In the photographing process of the digital camera 1, first, light that passes through a photographing lens 31 is incident on a charge couple device (CCD) 32 which is a solid state image device. A plurality of photo sensors are located on the light incident surface of the CCD 32. The light incident surface has a predetermined color filter pattern apart from a Bayer pattern. An image pick-up device such as a complementary metal oxide semiconductor (CMOS) image sensor may be used instead of the CCD 32. The optical image of a subject focused on the light incident surface of the CCD 32 is converted into electric charges according to the amount of light incident on each photo sensor. The electric charges accumulated at each photo sensor are read like a shift register by a read gate pulse added from a CCD driver 33, and are successively read like a voltage signal according to the electric charges by a register transmission pulse. The CCD 32 has a so-called electric shutter function that controls an electric charge accumulation time (shutter speed) of each photo sensor according to the timing of a shutter gate pulse.

A signal output from the CCD 32 is transmitted to an analog processor 34 and goes through processes such as correlation double sampling, color division, and gain control. Then, the signal is converted into a digital signal by an analog-to-digital (A/D) converter 35 and is transmitted to an image processor 36. A timing generator (TG) 37 transmits a synchronizing driving timing signal to the CCD driver 33, the analog processor 34, and the A/D converter 35, and each circuit is synchronized by the synchronizing driving timing signal.

The image processor 36 is a video signal processing element that includes, for example, a luminance and color difference signal generating circuit, a gamma compensating circuit, an image enhancing circuit, and a white balance compensating circuit. The image processor 36 processes an image signal according to a command signal transmitted from the system controller. The image signal input to the image processor 36 is converted into a luminance signal (Y signal) and a color difference signal (Cr and Cb signals), and after predetermined processes such as gamma compensation are simultaneously performed, is stored in a dynamic random access memory (DRAM) 40.

The image processor 36 and the video signal converter 95 are illustrated separately in FIG. 6. However, in the present embodiment, the image processor 36 may also receive an external video signal in addition to a still image and perform a function of the video signal converter 95 which generates moving picture data.

In the instance when a photographed image is output to a liquid crystal display (LCD) panel 60, image data is read from the DRAM 40 and transmitted to a controlling unit 10 via a bus. Also, data transmission to and from the DRAM 40 is controlled by a memory controller (not shown). The image data transmitted from the DRAM 40 is converted into a signal of a predetermined method for displaying (e.g., a color composite image signal of the National Television Standards Committee (NTSC) system), and is simultaneously converted into an analog signal by a digital-to-analog (D/A) converter 66. A signal for displaying that is converted and generated based on the image data is transmitted to an LCD driver 64 and output to an LCD panel 62 after going through the required signal conversions. Thus, an image is displayed on the LCD panel 62. A displaying element equipped in the digital camera 1 is not limited to the LCD panel 62, and other displaying devices that can display organic electroluminescence and other color display may be adopted.

The signal for displaying that is converted and generated based on the image data is output to a video out terminal VIDEO OUT via a video amplifier. It is possible to output the image signal to the outside by connecting an external image displaying device such as a TV monitor device to the image output terminal VIDEO OUT.

In the operation of the release switch of the operating unit 20, if the release switch is pressed in a photographing mode, an auto focusing function or a photographing start mode is performed. The release switch is configured in a two-step switch. A first switch S1 is when only half of the release switch is pressed, and a second switch S2 is when the release switch is fully pressed. When the controlling unit 10 detects the half-pressed release switch, an auto-focus (AF) and an auto-exposure (AE) are controlled, and when the controlling unit 10 detects the fully pressed release switch, a CCD exposure and reading control is performed to record an image.

An image processing unit 30 includes an element that acts as an auto operator that performs an operation needed to control the AF and AE. After performing, for example, a focus evaluation value operation or an AE operation based on the input image signal, the result of the operation is transmitted to the controlling unit 10. The controlling unit 10 controls a driving element that drives various motors of a barrel unit based on the result of the operation transmitted from the auto operator and moves a focus correcting lens of a photographing optical system to the focus. Simultaneously, an aperture is set to an appropriate aperture value, and controls the electric charge accumulation time (electrical shutter) of the CCD 32 and a mechanical shutter. Also, the system controller may control a luminescence of an external light emitting element (scrob) according to a command of the microprocessor. The image data read when the release switch 10 is fully pressed (S2=ON) is luminance and color difference processed in the image processing unit 30, and is compressed, if needed, and then stored in the DRAM 40. The image data stored in the DRAM 40 is recorded on the memory card 50 via the controlling unit 10. A compression standard of the image data may be MPEG including JPEG and other formats.

A video processing unit 90 includes a tuner 92, an IF processor 93 and a video signal converter 95. The TV tuner 92 selects a video signal of a TV, which is public broadcasting device, by tuning to a specific channel designated by the tuning control signal T.C received from the controlling unit 10. The TV tuner 92 receives the video signal via an antenna, and outputs to the IF processor the received video signal as an IF signal. The IF processor converts the signal and outputs a RGB composite baseband video signal. The video signal converter 95 converts the received composite video signal into an 8 bit luminance signal Y and an 8 bit color difference signal Cb and an 8 bit color difference signal Cr.

Next, the color difference signals Cb and Cr are filtered via a prefilter of the sub-sampling module 11 within the controlling unit 10, and then are sub-sampled into 4:2:2 or 4:2:0 color difference signals Cb\hat{ } and Cr\hat{ } to reduce the amount of data. In the compressing converting module 12, the luminance signal Y and 4:2:2 or 4:2:0 color difference signals Cb\hat{ } and Cr\hat{ } are lossy compressed using a DCT of a frequency substrate and quantization via conversion and quantization, thereby reducing the space repetitiveness of a video.

The composite video signal of the video processing unit 90 includes an audio signal. The audio signal is output to a speaker 16 via an audio codec 15.

When the digital camera 1 is in a reproducing mode, recent moving picture data or still image data recorded on the memory card 50 is read via the controlling unit 10. In the moving picture reproducing mode, the moving picture data is transmitted from the memory card 50 to the controlling unit 10, restored at the restoring module 13, converted into a displaying signal at the image D/A converter 66, and output to the LCD panel 62 via the LCD driver 64. Also, when an external displaying device besides the TV monitor device is connected to the image output terminal VIDEO OUT, a reproducing image is displayed on that external displaying device. A file that is the object of reproduction can be changed by operating an arrow key while in the reproducing mode. The audio signal included in the moving picture data is separated from the moving picture data and is transmitted to the audio codec 15. The audio codec 15 decodes the audio signal and outputs the audio signal via the speaker 16.

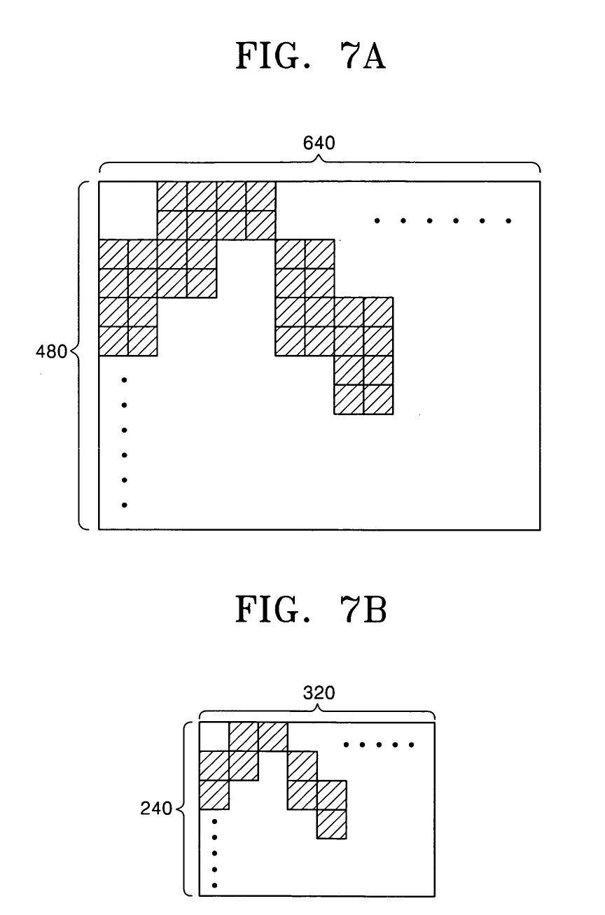

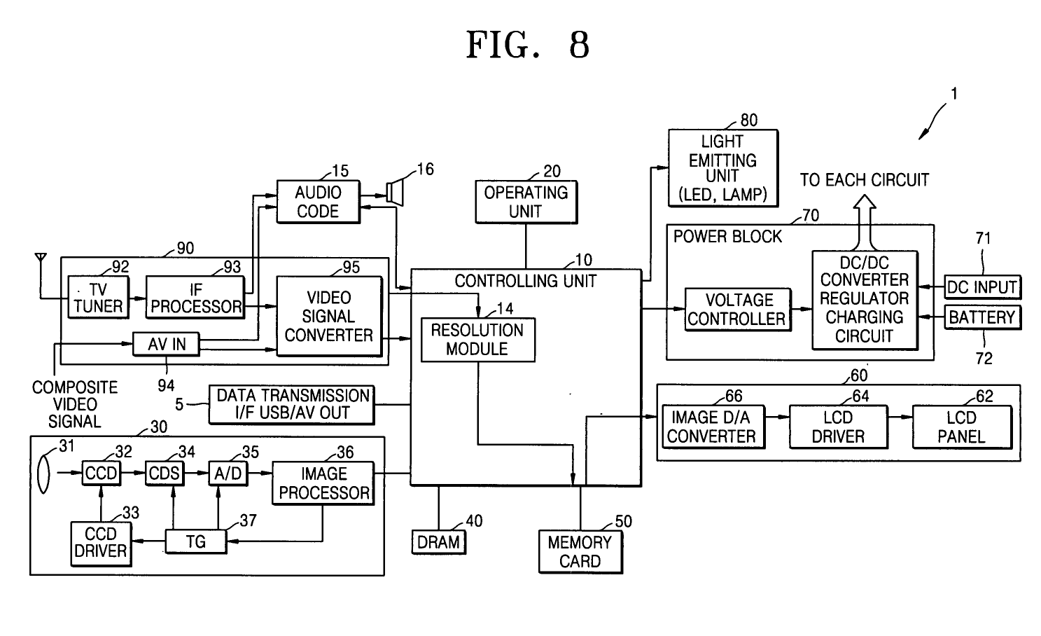

A digital camera according to another embodiment of the present invention will be described with reference to FIGS. 7A, 7B, and 8. However, the parts that are the same as the previous embodiment will be omitted.

FIG. 7A is a view illustrating a video signal having a horizontal and vertical pixel resolution that corresponds to that of public broadcasting. FIG. 7B is a view illustrating the video signal of FIG. 7A reduced by a predetermined ratio along horizontal and vertical pixels according to an embodiment of the present invention.

The video signal transmitted from a public broadcasting station has a resolution of 640×480 for a standard definition TV, and has a resolution of 1920×1080, 1366×768, 1280×720, 1280×768 etc. for a high definition TV. However, the displaying device installed in the digital camera has, for example, a resolution of 320×280 (QVGA), 160×128, or 128×128. Therefore, if the entire public broadcasting station video signal with a resolution of 640×480 or higher is converted into video data, a large amount of data is wasted. Whereas, in this invention, a memory device, which records video data, can proportionally reduce the physical amount of the video data when for example, in the case of the standard definition TV, a video signal having the resolution of 640×480 is converted to have the resolution of 320×280 of the displaying device of the digital camera.

FIG. 7A illustrates a video signal having a resolution or 640×480 in the case of the standard definition TV, the video signal being illustrated in horizontal and vertical pixels. FIG. 7B illustrates the video signal adoptively converted to have a resolution of 320×280 (e.g., converting 2×2 pixel into 1 pixel in a public broadcasting signal, mapping the pixel, and displaying the pixel) in horizontal and vertical pixels.

FIG. 8 is a block diagram of an entire digital camera 1 according to another embodiment of the present invention. A controlling unit 10 includes a microprocessor (not shown) and a system controller (not shown) that controls the digital camera 1 according to a predetermined program. The controlling unit 10 controls the operation of each circuit within the digital camera 1 based on a command signal from an operating unit 20. Also, the controlling unit 10 determines the state of the digital camera 1 based on a signal received from an internal circuit and a power block 70 and an input signal for the operation, and controls the luminescence of a light emitting unit 80.

Also, the digital camera 1 includes a data communication interface 5 to transmit and receive data between a personal computer and other external devices. The data communication interface 5 may include an A/V out terminal that outputs moving picture data restored by a restoring module, instead of, for example, a USB, IEEE 1394, and a Bluetooth.

In a photographing process of the digital camera 1, first, light that passes through a photographing lens 31 is incident on a CCD 32 that is a solid state image device. A plurality of photo sensors are located on a light incident surface of the CCD 32. The light incident surface has a predetermined color filter pattern apart from a Bayer pattern. An image pick-up device besides a CMOS image sensor may be used instead of the CCD 32. The optical image of a subject focused on the light incident surface of the CCD 32 is converted into electric charges according to the amount of light incident on each photo sensor. The electric charges accumulated at each photo sensor are read like a shift register by a read gate pulse added from a CCD driver 33, and are successively read like a voltage signal according to the electric charges by a register transmission pulse. The CCD 32 has a so-called electric shutter function that controls the electric charge accumulation time (shutter speed) of each photo sensor according to the timing of a shutter gate pulse.

A signal output from the CCD 32 is transmitted to an analog processor 34 and undergoes processes such as a correlation double sampling, color division, and gain control. Then, the signal is converted into a digital signal by an A/D converter 35 and transmitted to an image processor 36. A timing generator (TG) 37 transmits synchronizing driving timing signal to the CCD driver 33, the analog processor 34, and the A/D converter 35, and each circuit is synchronized by the synchronizing driving timing signal.

The image processor 36 is a video signal processing element that includes, for example, a luminance and color difference signal generating circuit, a gamma compensating circuit, an image enhancing circuit, and a white balance compensating circuit. The image processor 36 processes an image signal according to a command signal transmitted from the controlling unit 10. An image signal input to the image processor 36 is converted into a luminance signal (Y signal) and a color difference signal (Cr and Cb signals), and after predetermined processes such as gamma compensation are simultaneously performed, is stored in a DRAM 40.

The image processor 36 and the video signal converter 95 are illustrated separately in FIG. 8. However, in the present embodiment, the image processor 36 may also receive an external video signal in addition to a still image and perform a function of the video signal converter 95, which generates moving picture data.

A video processing unit 90 includes a TV tuner 92, an IF processor 93 and a video signal converter 95. The TV tuner 92 selects a video signal of a TV, which is public broadcasting device, by tuning to a specific channel designated by the tuning control signal T.C received from the controlling unit 10. The TV tuner 92 receives the video signal via an antenna and outputs to the IF processor the received video signal as an IF signal. The IF processor 93 converts the signal and outputs a RGB composite baseband video signal. The video signal processor 95 converts the received composite video signal into an 8 bit luminance signal Y and an 8 bit color difference signal Cb and an 8 bit color difference signal Cr.

The controlling unit 10 includes a resolution module 14 that receives the luminance signal Y and the color difference signals Cb and Cr, and reduces the original resolution of the luminance signal Y and the color difference signals Cb and Cr in a predetermined ratio that corresponds to a displaying resolution of a displaying unit 60. That is the luminance signal Y and the color difference signals. Cb and Cr are reduced and mapped in the resolution module 14 within the controlling unit 10 to correspond to a predetermined displaying resolution. Thus, the amount of video data is reduced.

Therefore, in a public broadcasting signal having a predetermined original resolution, n horizontal and vertical pixels can be each reduced into one horizontal pixel and one vertical pixel of the displaying resolution. For example, in a public broadcasting signal having 640×480 original resolution, each 2×2 pixel can be converted and mapped into one pixel and displayed. In this case, the amount of video data of the original resolution is proportionally reduced by ¼ according to the displaying resolution. Therefore, more video data can be stored in a memory card 50 having a limited storage space compared to a conventional memory card.

When the digital camera 1 is in the reproducing mode, recent moving picture data or still image data recorded on the memory card 50 is read via the controlling unit 10.

In the moving picture reproducing mode, the moving picture data is transmitted from the memory card 50 to the controlling unit 10, restored at the restoring module, converted into a displaying signal at the image D/A converter 66, and output to a LCD panel 62 via a LCD driver 64. Also, when an external displaying device besides a TV monitor device is connected to an image output terminal VIDEO OUT, a reproducing image is displayed on that external displaying device. A file that is the object of reproduction can be changed by operating an arrow key while in the reproducing mode. An audio signal included in the moving picture data is separated from the moving picture data and is transmitted to an audio codec 15. The audio codec 15 decodes the audio signal and outputs the audio signal via a speaker 16.

When the video data stored in the memory card 50 is data of 2×2 pixel of an original resolution converted into data of one pixel of a displaying resolution and stored in the memory card 50, the displaying resolution of the displaying unit 60 is lower than the original resolution of the public broadcasting video signal. Therefore, the video data can be directly output to the displaying unit 60 without having to be restored into the data of 2×2 pixel of the original resolution.

In a digital camera according to the present invention, functions of receiving a video signal and recording and reproducing a generated moving picture data on and from a memory card are added to a conventional digital camera combined with a TV receiver, which receives a video signal and displays the video signal via an LCD window.

Furthermore, provided is a digital camera that can convert and compress moving picture data generated after receiving a video signal, and then record and reproduce the moving picture data within a small volume and memory capacity range.

In addition, since high resolution moving picture data of public broadcasting is recorded on a memory card after being converted into a reduced resolution to correspond to a resolution displaying device mounted in a digital camera, the amount of moving picture data stored in the memory card, which has limited storage space, is reduced, thereby increasing a reproducing time.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A digital camera for recording and reproducing still image data generated by photographing a subject, and for receiving, recording and reproducing an external video signal, the digital camera comprising:
a still image processing unit that generates the still image data by photographing the subject;
a video processing unit that receives the external video signal, and generates moving picture data;
a memory card on which the still image data and the moving picture data are recorded;
a displaying unit that outputs the still image data and the moving picture data; and
a controlling unit that compresses the generated moving picture data and records the moving picture data on the memory card, and outputs the moving picture data stored in the memory card to the displaying unit after restoring the moving picture data.

2. The digital camera of claim 1, wherein the video processing unit comprises:
a receiving unit that receives the external video signal; and
a video signal converter that converts the received external video signal into a luminance signal and a color difference signal.

3. The digital camera of claim 2, wherein the receiving unit comprises: a tuner that receives a tuning control signal from the controlling unit, selects a specific channel based on the signal received from the controlling unit, receives a public broadcasting signal for that selected channel and outputs an intermediate frequency signal of the video signal for that specific channel; and an intermediate frequency processor that converts the selected video signal of the specific channel into an RGB baseband composite video signal; and wherein the video signal converter is adapted to convert a received RGB composite video signal into a luminance signal and a color difference signal.

4. The digital camera of claim 1, wherein the controlling unit comprises:
a sub-sampling module that receives the luminance signal and the color difference signal and reduces the color difference information of the color difference signal; and
a compressing module that compresses the luminance signal and the reduced color difference signal and generates the moving picture data; and wherein the controlling unit records the compressed moving picture data on the memory card.

5. The digital camera of claim 4, wherein the controlling unit comprises a restoring module that restores the luminance and the reduced color difference signal from the compressed moving picture data, receives the compressed moving picture data from the memory card, and outputs the compressed moving picture data to the displaying unit.

6. The digital camera of claim 1, wherein the video processing unit further comprises an audio/video input terminal that can receive an RGB composite video signal from an external device.

7. The digital camera of claim 1, further comprising an interface that outputs the moving picture data converted from the external video signal or the moving picture data stored in the memory card.

8. A digital camera for recording and reproducing still image data generated by photographing a subject, and for receiving, recording and reproducing an external video signal, the digital camera comprising:
a still image processing unit that generates the still image data by photographing the subject;
a video processing unit that receives an external video signal having a predetermined original resolution, and generates moving picture data;
a memory card on which the still image data and the moving picture data are recorded;
a displaying unit that outputs the still image data and the moving picture data according to a predetermined displaying resolution; and
a controlling unit that reduces the generated moving picture data to correspond to the displaying resolution of the displaying unit and records the moving picture data on the memory card, and outputs the moving picture data stored in the memory card after being reduced to the displaying unit.

9. The digital camera of claim 8, wherein the video processing unit comprises:
a receiving unit that receives the external video signal; and
a video signal converter that converts the received external video signal into a luminance signal and a color difference signal.

10. The digital camera of claim 9, wherein the receiving unit comprises:
a tuner that receives a tuning control signal from the controlling unit, selects a specific channel based on the signal received from the controlling unit, receives a public broadcasting signal for that selected channel, and outputs an intermediate frequency signal of the video signal for that specific channel; and
an intermediate frequency processor that converts the selected video signal of the specific channel into an RGB composite video signal, which is a baseband video signal; and wherein the video signal converter is adapted to convert the received RGB composite video signal into a luminance signal and a color difference signal.

11. The digital camera of claim 10, wherein the controlling unit comprises a resolution module that receives the luminance signal and the color difference signal and reduces the luminance signal and the color difference signal of the original resolution in a predetermined ratio that corresponds to the displaying resolution of the displaying unit; and wherein the controlling unit records the moving picture data having reduced resolution on the memory card.

12. The digital camera of claim 11, wherein the resolution module reduces n horizontal and vertical pixels of the original resolution of the luminance signal and the color difference signal into one horizontal and vertical pixel of the displaying resolution.

13. The digital camera of claim 8, wherein the video processing unit further comprises an audio/video input terminal that can receive an RGB composite video signal from an external device.

14. The digital camera of claim 8, further comprising an interface that outputs the moving picture data converted from the external video signal or the moving picture data stored in the memory card.

15. A method of operating a digital camera capable of still image photography for receiving an external video signal and displaying a moving picture image corresponding to the video signal, said method comprising the steps:
receiving an external video signal;
generating moving image data from the video signal;
recording the moving image data on a recording medium; and
reproducing said moving image data on a display.

16. The method of claim 15 further comprising the step of converting and compressing said moving image data after said generating step.

17. The method of claim of claim 15 where the external video signal is a high resolution video signal from a public broadcasting device, the method further comprising the steps of converting and compressing the moving image data after said generating step so as to record low resolution moving image data corresponding to a low resolution display of the digital camera.
